(19) United States
(12) Patent Application Publication
(10) Pub. No.: US 2025/0071227 A1
(43) Pub. Date: Feb. 27, 2025

(54) CONTROL METHOD THAT MAKES IT POSSIBLE TO USE HALFTONE PROCESSING, INFORMATION PROCESSING APPARATUS, AND STORAGE MEDIUM

(71) Applicant: CANON KABUSHIKI KAISHA, Tokyo (JP)

(72) Inventor: Hiroyuki Sakai, Chiba (JP)

(21) Appl. No.: 18/797,654

(22) Filed: Aug. 8, 2024

(30) Foreign Application Priority Data
Aug. 21, 2023 (JP) 2023-134053

(51) Int. Cl. H04N 1/405; G06K 15/02

(52) U.S. Cl. CPC H04N 1/4052; G06K 15/1881

(57) ABSTRACT

A non-transitory computer-readable storage medium storing a program for causing a computer to execute a control method for making it possible to extend a function of a general-purpose program which can be commonly used for printing apparatuses of a plurality of makers when printing is performed. An extension program causes the printing apparatus to execute halftone processing for generating image data which is provided for a printed matter to be printed based on print data generated by the general-purpose program and expresses halftone on the printed matter.

### BACKGROUND OF THE INVENTION

### Field of the Invention

The present invention relates to a control method that makes it possible to use halftone processing, an information processing apparatus, and a storage medium.

### Description of the Related Art

To a printing apparatus that performs printing, a host computer (information processing apparatus) is communicably connected which is capable of processing information in cooperation with the printing apparatus. As control software for controlling the printing apparatus, a printer driver installed e.g. from the printing apparatus into the host computer is used. By using the printer driver, the host computer can provide a print instruction to the printing apparatus. An operating system (hereinafter referred to as the OS) as the basic software is installed in the host computer in advance. The printer driver is configured based on the specification defined by the OS and can operate by being called from the OS. Further, the printer driver is different between vendors which supply printing apparatuses. That is, the printer driver is a printer driver unique to each model and suitable for each printing apparatus.

In recent years, Windows (registered trademark) provides a standard class driver (hereinafter sometimes referred to as the standard driver) which even printing apparatuses supplied by different vendors can commonly use. The standard driver is installed in the OS in advance. Then, by connecting a desired printing apparatus to a host computer having the OS in which the standard driver is installed, it is possible to use the standard driver. This makes it possible to omit installation of the printer driver unique to each model. Further, the standard driver can designate and use a print function equipped in the printing apparatus according to Print Device Capabilities (hereinafter referred to as the PDC) generated based on information acquired from the printing apparatus. This makes it possible to designate the print function for each printing apparatus, by using one standard driver. A function extension application (hereinafter sometimes referred to as the extension application) that extends a function can be associated with the standard driver. The extension application is provided from each vendor. Therefore, it is difficult to execute the function of the extension application, by only using the standard driver.

Japanese Laid-Open Patent Publication (Kokai) No. 2021-93081 discloses a support program used when printing is performed by a printing apparatus communicably connected to an information processing apparatus. The support program performs correction for reducing used amounts of coloring agents (toner or ink) in a case where a print instruction is provided to a general-purpose print program installed in an operating system of the information processing apparatus in advance and a saving mode for saving the coloring agents is selected. A correction processing function for performing the correction is not equipped in the general-purpose print program and the support program enables execution of the correction processing function.

Here, besides the correction processing function, a halftone selection function (halftone function), for example, is included in the functions of the extension application. The halftone selection function refers to a function of making it possible to select, in a case where processing for expressing halftone e.g. using AM screen is executed, one of patterns of e.g. dots, densities of lines (hereinafter referred to as line numbers), and angles, of the AM screen. Note that the AM screen refers to Amplitude Modulated Screening. For example, in a case where the halftone processing is applied to print data including characters, for example, jaggies (step-like jaggy shapes appearing on lines or outline) and breaks are sometimes generated depending on the density of the characters. In this case, for example, by increasing the line number of the AM screen, it is possible to eliminate the jaggies and the breaks, and therefore, it is possible to enhance the image quality. Further, a user can select whether or not to use the halftone selection function.

However, it is impossible to execute the halftone selection function by the support program disclosed in Japanese Laid-Open Patent Publication (Kokai) No. 2021-93081. As a result, there is a fear that it is impossible to adjust the print data to the intended image quality.

### SUMMARY OF THE INVENTION

The present invention provides a mechanism for executing halftone processing for expressing halftone with respect to a printed matter printed based on print data generated by a general-purpose program which can be commonly used for printing apparatuses of a plurality of makers to perform printing.

In a first aspect of the present invention, there is provided a non-transitory computer-readable storage medium storing a program for causing a computer to execute a method of controlling a function of a general-purpose program which can be commonly used for printing apparatuses of a plurality of makers, such that the function can be extended, wherein the method comprises causing the printing apparatus to execute halftone processing for generating image data for expressing halftone on a printed matter printed based on print data generated by the general-purpose program.

In a second aspect of the present invention, there is provided a non-transitory computer-readable storage medium storing a program for causing a computer to execute a method of controlling a function of a general-purpose program which can be commonly used for printing apparatuses of a plurality of makers, such that the function can be extended, wherein the method comprises executing halftone processing for generating image data for expressing halftone on a printed matter printed based on print data generated by the general-purpose program.

According to the present invention, it is possible to execute halftone processing for expressing halftone with respect to a printed matter printed based on print data generated by a general-purpose program which can be commonly used for printing apparatuses of a plurality of makers to perform printing.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a printing system according to a first embodiment of the present invention.

FIGS. 2A and 2B are block diagrams each showing a software configuration of the printing system.

FIG. 3 is an image diagram showing changes in image data, generated by halftone processing.

FIGS. 4A to 4C are diagrams each showing an example of a screen displayed on a display section of the printing system.

FIG. 5 is a flowchart of a print function information-editing process performed by a print function extension unit, for editing print function information.

FIG. 6 is a diagram showing an example of a list of capabilities information of a printing apparatus.

FIG. 7 is a diagram showing an example of a list of print functions supported by an extension application.

FIG. 8 is a diagram showing an example of a list of capabilities information of general-purpose printing software.

FIG. 9 is a sequence diagram showing a process executed between a drawing application, the general-purpose printing software, the extension application, and the printing apparatus, after the drawing application receives print settings.

FIG. 10 is a block diagram showing a software configuration of the printing system according to a second embodiment of the present invention.

FIG. 11 is a flowchart of a print function information-editing process performed by the print function extension unit, for editing print function information.

FIG. 12 is a diagram showing an example of a list of capabilities information of the printing apparatus.

FIG. 13 is a sequence diagram showing a process executed between the drawing application, the general-purpose printing software, the extension application, and the printing apparatus, after the drawing application receives print settings.

FIG. 14 is a sequence diagram showing a process executed between the drawing application, the general-purpose printing software, the extension application, and the printing apparatus, after the drawing application receives print settings in a third embodiment of the present invention.

FIG. 15 is a block diagram showing a software configuration of a printing system according to a fourth embodiment of the present invention.

FIG. 16 is a sequence diagram showing a process executed between the drawing application, the general-purpose printing software, the extension application, and the printing apparatus, after the drawing application receives print settings.

FIGS. 17A to 17D are diagrams each showing an example of a screen displayed on the display section of the printing system.

### DESCRIPTION OF THE EMBODIMENTS

The present invention will now be described in detail below with reference to the accompanying drawings showing embodiments thereof. The configurations described in the following embodiments are given only by way of example, and are by no means intended to limit the scope of the present invention. For example, each component of the configurations of the present invention can be replaced by a desired component which can exhibit the same function. Further, a desired component can be added. Further, two or more desired components (features) of the embodiments can be combined.

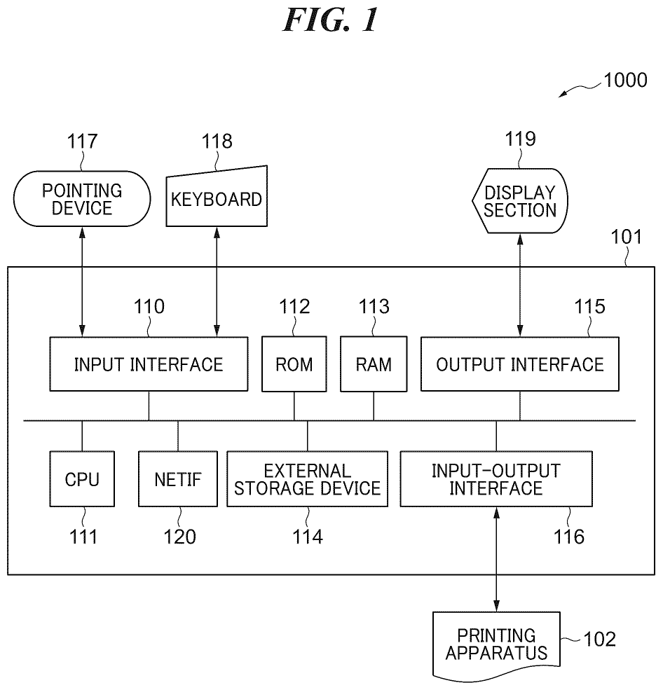

A first embodiment of the present invention will be described below with reference to FIGS. 1 to 9.

FIG. 1 is a block diagram showing a hardware configuration of a printing system according to the first embodiment. As shown in FIG. 1, the printing system, denoted by reference numeral 1000, includes a host computer 101, a printing apparatus 102, a keyboard 118, a pointing device 117, and a display section 119, and these components are communicably connected to each other. The host computer 101 is an information processing apparatus, and includes an input interface 110, a central processing unit (CPU) 111, a read only memory (ROM) 112, a random access memory (RAM) 113, an external storage device (recording medium) 114, an output interface 115, an input-output interface 116, and a network interface (NET IF) 120. Note that as the host computer 101, for example, a desktop-type personal computer can be used, but this is not limitative, and a laptop-type personal computer, a tablet terminal, a smartphone, or the like can also be used.

The CPU 111 executes e.g. a program stored in the ROM 112 or the external storage device 114. The ROM 112 stores an initialization program. The external storage device 114 stores an application program group, an operating system (OS), print data generation software, and a variety of other data. Note that in the present embodiment, as the OS, Windows (registered trademark) 11 of Microsoft (registered trademark) is installed in the host computer 101. The RAM 113 is used e.g. as a work memory when a variety of programs stored in the external storage device 114 are executed, and the variety of programs can be operated within the host computer 101. To the input interface 110, the pointing device 117 and the keyboard 118 as input devices are connected. To the output interface 115, the display section 119 as a display device is connected. On the display section 119, for example, a print settings screen 400A and a detailed settings screen 400C, described hereinafter, are displayed. The NET IF 120 performs control for transferring data to and from an external apparatus via a network. To the input-output interface 116, the printing apparatus 102 is connected. With this, the host computer 101 is enabled to communicate with the printing apparatuses 102 of a plurality of makers, in other words, process information between the printing apparatuses 102 of a plurality of makers and itself, regardless of the makers of the printing apparatus 102.

As the printing apparatus 102, for example, a multifunction peripheral (MFP) having a plurality of functions, such as copy, print, and FAX functions, can be used, but this is not limitative. Further, although printing performed by the printing apparatus 102 is electrophotographic printing in the present embodiment, this is not limitative, but for example, the printing apparatus 102 can perform e.g. printing by the inkjet method. Further, although in the present embodiment, the host computer 101 and the printing apparatus 102 are configured as separate apparatuses, this is not limitative. For example, the host computer 101 and the printing apparatus 102 can be configured as an integrated apparatus.

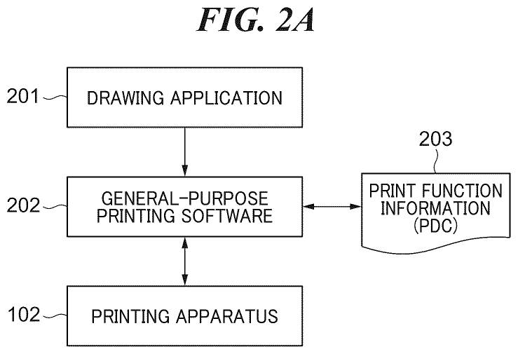

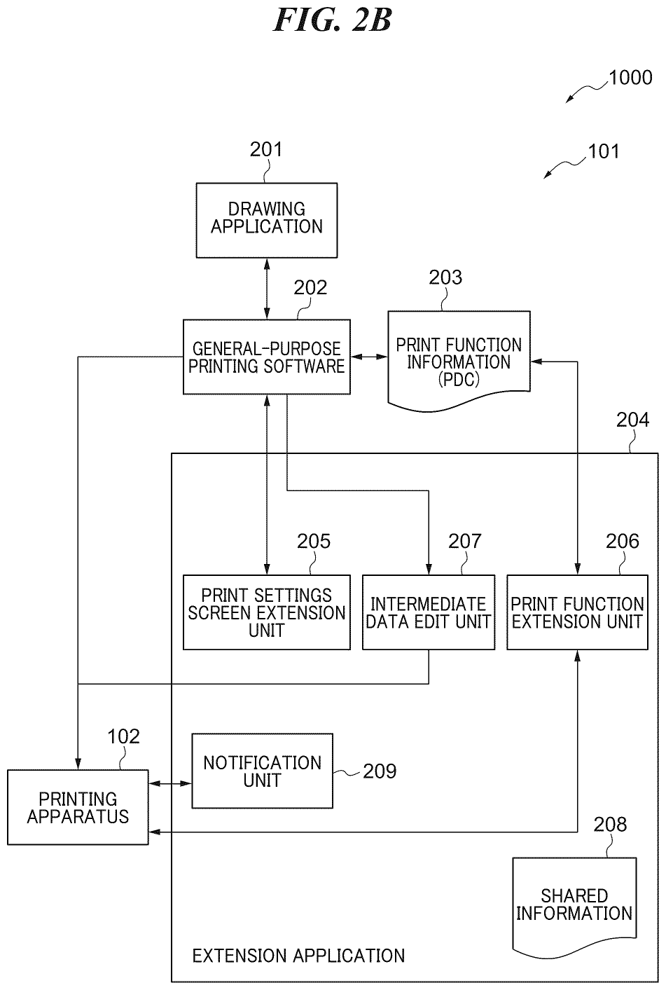

FIGS. 2A and 2B are block diagrams each showing a software configuration of the printing system. FIG. 2A shows a general configuration in a case where an extension application (program) 204 is not associated with general-purpose printing software (general-purpose program) 202 and the printing apparatus 102. FIG. 2B shows a configuration in a case where the extension application 204 is associated with the general-purpose printing software 202 and the printing apparatus 102. The general-purpose printing software 202 can be commonly used for the printing apparatuses 102 of the plurality of makers when printing is performed, and has been installed in the OS in advance. As the general-purpose printing software 202, a program which operates based on the Internet Printing Protocol (IPP) is used. The extension application 204 is an extension program (program for executing the control method) which can extend the function of the general-purpose printing software 202. For example, the extension application 204 is stored in the external storage device 114, together with the OS including the general-purpose printing software 202. With this, the host computer 101 has the general-purpose printing software 202 and the extension application 204.

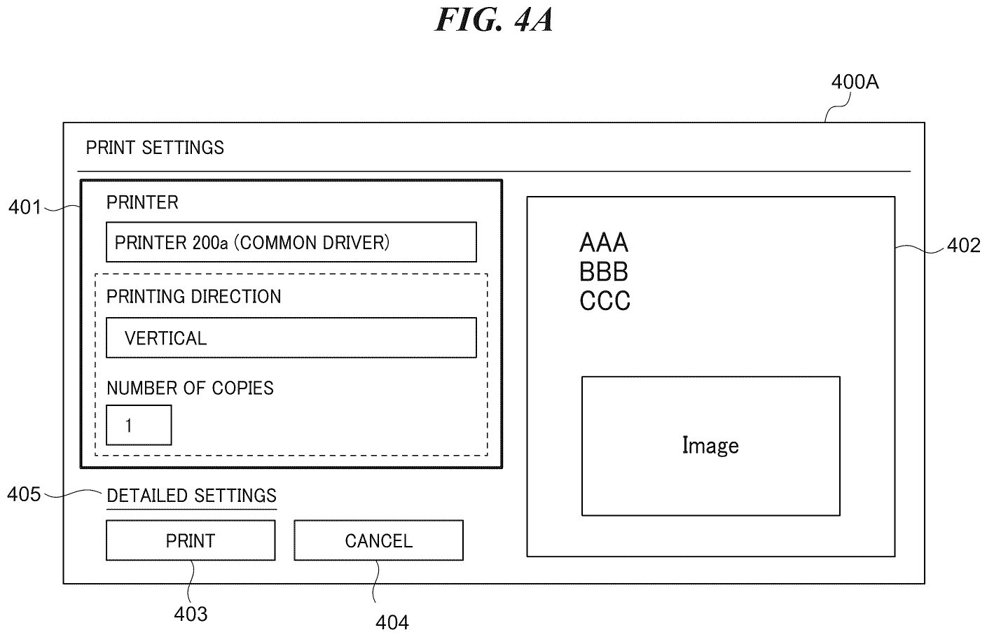

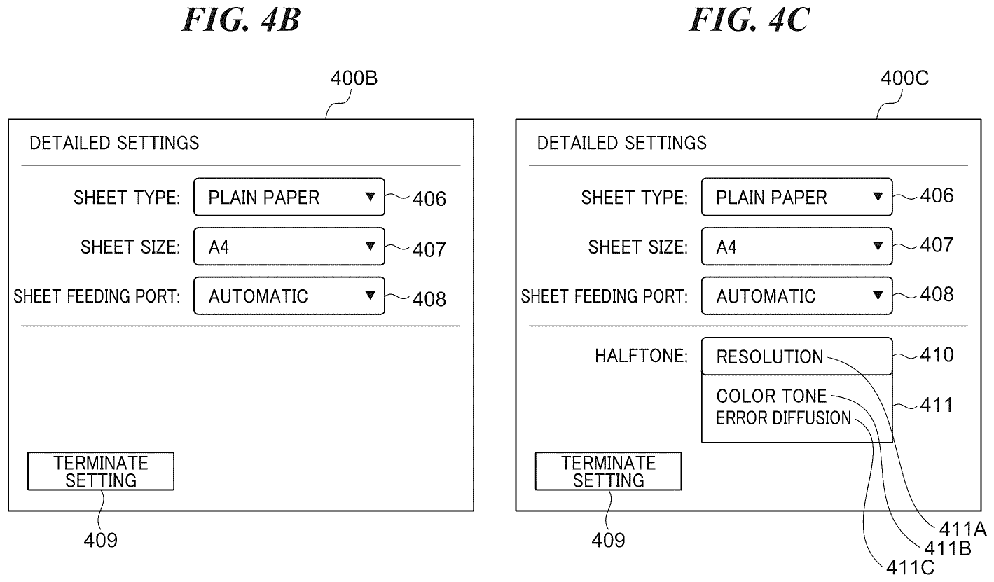

First, the case where the extension application 204 is not associated with the general-purpose printing software 202 and the printing apparatus 102 will be described with reference to FIG. 2A. A drawing application 201 is software for generating contents (print data) to be printed by the printing apparatus 102. The drawing application 201 is not particularly limited, but, as the drawing application 201, there can be mentioned, for example, a document generation application and a spreadsheet application. The drawing application 201 issues a print instruction to the OS upon receipt of a print request from a user e.g. via the keyboard 118. The print instruction includes print settings information for instructing the operations of the general-purpose printing software 202 and the printing apparatus 102. The print settings information is also referred to as the Print Ticket (PT). Further, the drawing application 201 can display the print settings screen 400A (see FIG. 4A) provided by one of the general-purpose printing software 202, the OS, and the drawing application 201, on the display section 119, so as to output the print settings information. Further, when a control 405 on the print settings screen 400A is operated (pressed), the general-purpose printing software 202 can display a detailed settings screen 400B (see FIG. 4B) or the detailed settings screen 400C (see FIG. 4C) on the display section 119. The print settings screen 400A to the detailed settings screen 400C will be described hereinafter. The print settings screen 400A includes setting items indicating print functions which can be set according to capabilities information acquired from the general-purpose printing software 202, i.e. information which can be set as the print settings, and control items indicating settings of the setting items. The capabilities information is also referred to as Print Capabilities (hereinafter sometimes referred to as the PC). Further, it is also possible to determine, based on the capabilities information, whether or not the printing apparatus 102 can execute halftone processing. The halftone processing refers to processing for generating image data expressing the halftone on a printed matter printed by the printing apparatus 102.

The general-purpose printing software 202 determines a PC based on print function information 203. The print function information 203 is data indicating all print functions which can be set, settings of those print functions, and print functions on which an exclusive relationship between settings thereof, for example, is described. The print function information 203 is also referred to as the Print Device Capabilities (PDC). The print function information 203 is included in a configuration file of the general-purpose printing software 202 and is disposed in the external storage device 114 as an unchangeable file. Alternatively, the print function information 203 is dynamically generated by the general-purpose printing software 202. Specifically, the general-purpose printing software 202 acquires attribute data of the printing apparatus 102 from the printing apparatus 102. The general-purpose printing software 202 generates the print function information 203 according to attribute information included in this attribute data. Note that in a case where the print function information 203 is dynamically generated as described above, the print function information 203 can be edited. Further, the attribute data of the printing apparatus 102 is a response acquired by issuing an IPP of “Get-Printer-Attributes” to the printing apparatus 102. The response includes functions which can be designated in the printing apparatus 102, i.e. the attribute information indicating the capabilities of the printing apparatus 102 and settings associated with the attribute information. Further, the response is stored in the RAM 113.

With this configuration, the general-purpose printing software 202 enables a user to designate a print function which can be used in the printing apparatus 102 according to the printing apparatus 102 connected to the general-purpose printing software 202. With this, without depending on the printing apparatus 102 connected to the general-purpose printing software 202, even in a case where a printing apparatus having different functions or a printing apparatus developed by a different printing apparatus maker is connected, it is possible to designate a print function which can be used in the connected printing apparatus. Note that in the present embodiment, the general-purpose printing software 202 is configured to use the IPP Class Driver installed in Windows (registered trademark) 11. The IPP Class Driver is a printer driver that executes print processing according to the specification of the standard print protocol referred to as the IPP and is packaged in the OS package. The IPP Class Driver is not a printer driver specific to a model of the printing apparatus 102, but a standard class driver which can be commonly used by the printing apparatuses 102 of printer makers. Further, the IPP Class Driver acquires the capabilities information of each printing apparatus 102 and generates the print function information 203 based on the acquired information. Further, the extension application 204 can be associated with the general-purpose printing software 202. This makes it possible to cause the general-purpose printing software 202 to execute a function which is not equipped in the general-purpose printing software 202. The IPP Class Driver (general-purpose printing software 202) does not support execution of the halftone processing for expressing halftone on an image printed by the printing apparatus 102. This is because the halftone processing is a function uniquely executed by the printing apparatus 102 manufactured by each printer maker. The extension application 204 can extend the function of the IPP Class Driver such that it is possible to execute the halftone processing which cannot be executed by the IPP Class Driver. Although in the present embodiment, the IPP Class Driver cannot execute the halftone processing and the extension application 204 enables the IPP Class Driver to execute the halftone processing, this is not limitative. For example, the IPP Class Driver can be configured to be capable of executing part of the halftone processing, and the extension application 204 can further extend the execution range by compensating for the rest of the halftone processing.

A halftone selection function is a function that enables a user to select, when the halftone processing, such as AM screen, is applied to print data, conditions of e.g. the dots and the number and angle of lines of the AM screen which is applied. Note that the AM screen refers to Amplitude Modulated Screening. For example, in a case where the halftone processing is applied to print data including characters, jaggies (a kind of turbulence (noise) generated in a digitalized image, i.e. step-like jaggy shapes appearing on lines or outline) and breaks are sometimes generated depending on the density of the characters. In this case, by increasing the line number of the AM screen, it is possible to eliminate the jaggies and the breaks and thereby enhance the image quality. Further, the user can select the following two types of printing: The first type of printing is printing in which the halftone processing is applied to an image to be printed, by changing the conditions of the AM screen through the use of the halftone selection function. The second type of printing is printing in which the halftone processing is applied to the image by using the default AM screen without using the halftone selection function. The halftone processing includes, besides the processing using the AM screen (AM screen processing), processing using an error diffusion method. In the AM screen processing, it is possible to express gradation by converting an image having continuous gradation into binary dots, which are different in size, according to signal values, and arranging the converted dots in a specified grid pattern. In the processing using the error diffusion method, it is possible to express gradation of an image having continuous gradation, using binary values, based on a difference between a desired reference value and a signal value of each pixel referred to starting from an end of the image.

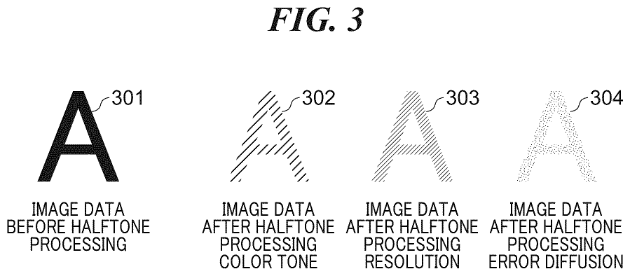

FIG. 3 is an image diagram showing changes in image data, generated by halftone processing. In the present embodiment, the patterns used for the halftone processing include three types: a color tone pattern, a resolution pattern, and an error diffusion pattern. Further, although in the present embodiment, an 8-bit grayscale image is used as an input image, and processing for converting the input image into a 1-bit monochrome image by performing the halftone processing will be described by way of example, this is not limitative. For example, the input image can be an image having a plurality of color components, such as a CMYK image, and the image obtained after performing the halftone processing can be an image formed by converting the input image to an image having a number of bits more than 1 bit, such as 2 bits or 4 bits. First, the color tone pattern will be described. An image 301 is 8-bit grayscale image data generated by the printing apparatus 102. In a case where the AM screen processing is applied to the image 301, an image 302 is generated as a 1-bit monochrome image. The image 302 is an image on which the halftone processing has been performed using the color tone pattern. In the image 302, the density of lines formed by dots in the AM screen is set to be relatively low. Although in the present embodiment, the density of lines is set to 106 lines per 1 inch (1 pi), this is not limitative, but for example, the density of lines can be set to be lower than 106 1 pi, or higher than 106 1 pi. The halftone processing using the color tone pattern is capable of converting the image data while preserving the gradation reproducibility of the image data, but there is a fear that jaggies are generated in edge portions. Therefore, the halftone processing using the color tone pattern is suitable for a nature photo and the like.

Next, the resolution pattern will be described. In a case where the AM screen processing based on the resolution pattern is performed on the image 301, an image 303 is generated as a 1-bit monochrome image. The image 303 is an image on which the halftone processing has been performed using the resolution pattern. In the image 303, the density of lines formed by dots in the AM screen is set to be higher than in the image 302. The density of lines of the image 303 is set e.g. to 212 1 pi in the present embodiment but is not limited to this insofar as the image 303 is higher in the density of lines than the image 302, and for example, the density can be set to be lower or higher than 212 1 pi. In the halftone processing using the resolution pattern, the jaggies in the edge portions are reduced, but the gradation reproducibility of the image data tends to be lowered. Therefore, the halftone processing using the resolution pattern is suitable e.g. for a document image including a lot of characters.

Next, the error diffusion pattern will be described. In a case where the halftone processing using the error diffusion method is applied to the image 301, an image 304 is generated as a 1-bit monochrome image. The error diffusion method can improve the reproducibility of thin lines but is higher in calculation costs than the AM screen processing and can generate special noise referred to as worm noise in a specific tone. Therefore, the halftone processing using the error diffusion method is suitable for an image including thin lines, such as a drawing. For example, in a case where jaggies of characters included in image data are noticeable, the user changes the halftone processing pattern by using the halftone selection function on the printer driver or on a user interface screen (UI) screen displayed on the display section 119 of the printing apparatus 102 and performs printing again. With this, the user can adjust the image to the intended image quality. Note that although in the present embodiment, the description is given of the example in which the line number of one pattern is applied to the whole image data, this is not limitative. For example, in a case where data indicative of the attributes of objects within the image data is attached to the image data, the halftone processing pattern can be switched, on an object-by-object basis, based on the attributes.

Here, the description returns to FIG. 2A. The OS generates intermediate data (sometimes referred to as the “input data”) and sends the generated intermediate data to the general-purpose printing software 202 based on a print instruction output from the drawing application 201. The data output for printing by the drawing application 201 is not particularly limited but is preferably e.g. data of Extensible Markup Language (XML) Paper Specification format (XPS format). Further, the data output for printing by the drawing application 201 can be data of the Graphic Device Interface (GDI) format. In a case where the IPP Class Driver is used as the general-purpose printing software 202, if the data output by the drawing application 201 is the GDI format data, the OS converts the GDI data to XPS data. Then, the OS sends the converted XPS data to the general-purpose printing software 202 as the intermediate data. Further, if the data output by the drawing application 201 is the XPS data, the OS sends the XPS data to the general-purpose printing software 202 as the intermediate data. Note that the intermediate data includes drawing data as information on e.g. characters and figures to be formed, on a printing medium and print settings information set by the user.

The general-purpose printing software 202 converts the intermediate data to print data (image data) which can be processed, i.e. printed by the printing apparatus 102, and transmits the print data to the printing apparatus 102. Here, the print data in the present embodiment is Page Description Language (PDL) data based on the IPP. For example, the PDL data is data of the Portable Document Format (PDF or of the PWG-Raster format. Note that the print data includes drawing data as information on characters, figures, or the like, which are to be formed on a printing medium, and print setting attribute information generated based on the print settings information set by the user, for designating the print settings. The print setting attribute information includes functions which can be designated in the printing apparatus 102, i.e. the attribute information indicating the capabilities of the printing apparatus 102 and settings associated with the attribute information.

The printing apparatus 102 performs printing on a printing medium based on the print data transmitted from the general-purpose printing software 202. At this time, the printing apparatus 102 can form the drawing data included in the print data on the printing medium, by performing the operation according to the print setting attribute information included in the print data. Note that the print setting attribute information includes, for example, attribute information for designating print quality settings, such as image quality priority and speed priority, and double-sided printing or single-sided printing, and settings of the attribute information. For example, in a case where the attribute information designating double-sided printing is included in the print setting attribute information, the printing apparatus 102 can execute double-sided printing.

A case where the extension application 204 is associated with the general-purpose printing software 202 and the printing apparatus 102 will be described with reference to FIG. 2B. As shown in FIG. 2B, differently from FIG. 2A, the extension application 204 is added. That is, the host computer 101 includes the drawing application 201, the general-purpose printing software 202, and the print function information 203, and further includes the extension application 204. The extension application 204 is software for extending the function of the general-purpose printing software 202. Note that the extension application 204 is software which has not been included (packaged) in the OS in advance. Therefore, the extension application 204 is downloaded from a server (not shown) via the Internet and is installed in the host computer 101 by the user operating the host computer 101. Alternatively, when the printing apparatus 102 is connected to the host computer 101, the extension application 204 can be automatically installed in the host computer 101 based on the connection. Specifically, in a case where the printing apparatus 102 is connected to the host computer 101, the OS acquires device identification information from the printing apparatus 102. The OS can download the extension application 204 associated with the device identification information from the server via the Internet and install the downloaded extension application 204. As a result, the general-purpose printing software 202 and the extension application 204 are held in the host computer 101 as the control programs separate from each other. Note that the general-purpose printing software 202 and the extension application 204 are sometimes updated to upgrade their versions, respectively. The processing for updating the general-purpose printing software 202 and the processing for updating the extension application 204 in this case are performed at the same timing or at respective different timings. Further, a trigger with which the general-purpose printing software 202 is acquired by the host computer 101 and a trigger with which the extension application 204 is acquired by the same can be the same trigger or different triggers. Further, in a case where the extension application 204 is installed, the OS associates the extension application 204 with the general-purpose printing software 202 and the printing apparatus 102.

As shown in FIG. 2B, the extension application 204 is capable of exchanging information with (transmitting and receiving information to and from) the general-purpose printing software 202 and the printing apparatus 102, respectively. More specifically, the extension application 204 is associated with the general-purpose printing software 202 and the printing apparatus 102. In the present embodiment, the extension application 204 includes a print settings screen extension unit 205, a print function extension unit 206, an intermediate data edit unit 207, and a notification unit 209. Further, the extension application 204 includes shared information 208 which can be accessed from the print settings screen extension unit 205, the print function extension unit 206, the intermediate data edit unit 207, and the notification unit 209. The shared information 208 is a file stored in the external storage device 114 or information stored in the RAM 113. The extension application 204 can write and read the shared information 208 by using an Application Program Interface (API) provided by the OS.

Note that the extension application 204 can terminate the whole operation of the extension application 204 when processing operations performed by the units of the print settings screen extension unit 205 to the notification unit 209 are terminated. In this case, the OS starts the extension application 204 whenever a request for executing processing of each unit is received. Further, for example, in a case where the processing of the print settings screen extension unit 205 is terminated, the OS terminates the whole operation of the extension application 204. Further, during the processing operation of each unit of the print settings screen extension unit 205 to the notification unit 209, the extension application 204 can cancel the processing. In this case, a job being processed on the print queue is deleted by the OS. As described above, the drawing application 201 issues a print instruction to the OS, upon receipt of a print request from the user. Further, the drawing application 201 can display the print settings screen. In the configuration shown in FIG. 2B, the drawing application 201 can display the print settings screen 400A (detailed settings screen 400C) provided by the print settings screen extension unit 205 (extension application 204). Further, the print settings screen extension unit 205 can store the detailed settings set by the user in the shared information 208. Details of the print settings screen extension unit 205 will be described hereinafter.

The intermediate data edit unit 207 acquires the intermediate data from the general-purpose printing software 202. Then, the intermediate data edit unit 207 converts the intermediate data to print data and then transmits the print data to the printing apparatus 102. Further, the intermediate data edit unit 207 acquires the detailed settings information from the shared information 208 and adds the detailed settings to the print data. The printing apparatus 102 performs printing on a sheet surface based on the print data received from the intermediate data edit unit 207. Note that the extension application 204 can be configured to acquire print data generated by the general-purpose printing software 202 and add the detailed settings to the acquired print data. Further, even in the configuration shown in FIG. 2B, there is a case where the halftone processing is not performed. In this case, the general-purpose printing software 202 can transmit the print data to the printing apparatus 102 without using the extension application 204.

The print function extension unit 206 can edit the print function information 203 (PDC) generated by the general-purpose printing software 202 or the OS. This makes it possible to add a function provided by the extension application 204. Further, it is also possible to add a function which can be executed by the printing apparatus 102 but cannot be executed by the general-purpose printing software 202 and add an exclusive relationship between settings of the print functions. The OS starts the print function extension unit 206 when the extension application 204 is first associated with the printing apparatus 102 and the general-purpose printing software 202. Further, the OS can start the print function extension unit 206 at a timing other than this (such as a timing at which the OS is started). Even in a case where a function associated with printing is extended later by starting the print function extension unit 206 as described above, the print function extension unit 206 can detect the extended function and add the detected function to the print function information 203. As an example of the case where a function associated with printing is extended later, there is a case where an optional apparatus (such as finisher) is added to the printing apparatus 102 later.

The notification unit 209 can notify, when an error of the printing apparatus 102 has occurred, the occurrence of the error. For example, in a case where a no-sheet error has occurred in the printing apparatus 102, the general-purpose printing software 202 detects occurrence of this error. The OS displays occurrence of the no-sheet error as a result of the detection performed by the general-purpose printing software 202 on the display section 119 as a message by using a notification function referred to as the toast notification as one of the functions of the OS. Note that when the user operates the toast notification, the notification unit 209 is called by the OS, and a UI screen of the notification unit 209 is displayed. On the UI screen, a detailed message concerning the no-sheet error, a sheet supply method or the like can be displayed.

As described above, in the present embodiment, it can be said that the extension application 204 has the following four functions: The first function is a function of displaying the setting screen. This function is executed by the print settings screen extension unit 205. The second function is a function of editing intermediate data to convert the intermediate data into print data and adding detailed settings to the print data. This function is executed by the intermediate data edit unit 207. The third function is a function of extending a function which can be designated by the print data generation software. This function is executed by the print function extension unit 206. The fourth function is a function of displaying a screen in response to occurrence of an error in the printing apparatus 102. This function is executed by the notification unit 209. Note that the configuration of the extension application 204 is not limited to the configuration having these four functions but it is preferable that the configuration of the extension application 204 has at least one function, and further, the extension application 204 can be configured to further have another function. Further, when the extension application 204 once transmits print data to the printing apparatus 102, the extension application 204 cannot display a screen, such as a guide, associated with the print data during the processing performed by each unit.

FIGS. 4A to 4C are diagrams each showing an example of a screen displayed on the display section of the printing system. FIG. 4A shows the print settings screen displayed by the drawing application 201. FIG. 4B shows the detailed settings screen displayed in a case where the extension application 204 is not associated with the printing apparatus 102 and the general-purpose printing software 202. FIG. 4C shows the detailed settings screen displayed in a case where the extension application 204 is associated with the printing apparatus 102 and the general-purpose printing software 202. Note that a unit or module that displays each screen is not particularly limited. For example, the print settings screen extension unit 205 can be configured to only generate a display screen. In this case, the print settings screen extension unit 205 sends the generated display screen to the drawing application 201 via the general-purpose printing software 202. The drawing application 201 can be configured to display the acquired display screen.

The print settings screen 400A shown in FIG. 4A includes a control (button) 401, a control 402, a control 403, a control 404, and the control 405. With the control 401, it is possible to set the printing apparatus 102 to be used for printing, a direction of printing to be performed by the printing apparatus 102, and the number of copies to be printed by the printing apparatus 102. FIG. 4A shows an example that the printing apparatus 102 to be used for printing is set to a printer 200a, the direction of printing to be performed by the printing apparatus 102 is set to a vertical direction, and the number of copies to be printed by the printing apparatus 102 is set to 1. The control 402 displays a preview screen. With the control 403, it is possible to instruct the start of printing performed by the printing apparatus 102. With the control 404, it is possible to instruct cancellation of printing performed by the printing apparatus 102. With the control 405, detailed settings can be made. By operating the control 405, the detailed settings screen 400B (see FIG. 4B) or the detailed settings screen 400C (see FIG. 4C) is displayed by the general-purpose printing software 202 or the print settings screen extension unit 205.

The detailed settings screen 400B shown in FIG. 4B includes a control 406, a control 407, a control 408, and a control 409. With the control 406, it is possible to select and set a type of sheets used for printing performed by the printing apparatus 102. In the illustrated example in FIG. 4B, plain paper is selected by way of example. With the control 407, it is possible to select and set a size of sheets used for printing performed by the printing apparatus 102. In the illustrated example in FIG. 4B, A4 is selected by way of example. With the control 408, it is possible to select a sheet feeding port of sheets used for printing performed by the printing apparatus 102. In the illustrated example in FIG. 4B, automatic selection is selected by way of example. With the control 409, it is possible to terminate the settings by the control 406 to the control 408. Further, by operating the control 409, the display screen returns to the print settings screen 400A shown in FIG. 4A.

Similar to the detailed settings screen 400B, the detailed settings screen (setting screen) 400C shown in FIG. 4C includes the control 406, the control 407, the control 408, and the control 409. Further, the detailed settings screen 400C includes a control 410 added thereto. With the control 410, it is possible to select and set an execution condition (setting items of the halftone setting) used when the halftone processing is executed. By operating the control 410, a list 411 is displayed. The list 411 includes a resolution (resolution section) 411A, a color tone (color tone section) 411B, and error diffusion (error diffusion section) 411C, as the execution conditions of the halftone processing (hereinafter sometimes referred to as the halftone selection function), and one of these can be selected. By selecting the resolution 411A, it is possible to determine the resolution pattern as the halftone processing pattern. By selecting the color tone 411B, it is possible to determine the color tone pattern as the halftone processing pattern. By selecting the error diffusion 411C, it is possible to determine to the error diffusion pattern as the halftone processing pattern. Thus, by selecting the halftone which realizes the desired image quality from the list 411, it is possible to switch the halftone processing pattern and perform printing. Note that the detailed settings screen 400C can include a preview screen (sample image) of an image on which the halftone processing has been performed as information concerning a result of switching the halftone processing pattern. Further, in a case where the resolution 411A or the color tone 411B is selected, the processing using the AM screen is used as the halftone processing. Further, the resolution 411A is higher in the density of dots or lines of the AM screen than the color tone 411B. With this, as described hereinafter, image data from which jaggies have been reduced is generated, compared with a case where the halftone processing using the color tone pattern is performed.

In the present embodiment, in a case where printing is performed without executing the halftone processing (without using the halftone selection function), the halftone processing is applied by using the color tone pattern. Further, as the execution condition of the halftone processing, although in the present embodiment, the resolution 411A, the color tone 411B, and the error diffusion 411C are included, this is not limitative, but at least one item of these can be included, and further, any other item can be added. Further, in the printing system 1000, by selecting the resolution 411A, a resolution changing screen (not shown) on which the resolution in the halftone can be changed to a desired resolution can be displayed on the display section 119. The user can select a desired resolution on this resolution changing screen. Further, by selecting the color tone 411B, a color tone-changing screen (not shown) on which the color tone in the halftone can be changed to a desired color tone can be displayed on the display section 119. The user can change the color tone to a desired color tone on this color tone-changing screen. Further, by selecting the error diffusion 411C, an error diffusion-changing screen (not shown) on which the number of colors and the number of gradations of the image in the error diffusion method can be changed to a desired magnitude can be displayed on the display section 119. The user can change the number of colors and the number of gradations to desired values on this error diffusion-changing screen.

Here, a reason why the items included in the detailed settings screen 400B shown in FIG. 4B and the items included in the detailed settings screen 400C shown in FIG. 4C are different from each other will be described. The detailed settings screen 400B and the detailed settings screen 400C are generated based on the print function information (capabilities information), respectively. As described above, the general-purpose printing software 202 does not support execution of the halftone processing. Therefore, the halftone selection function cannot be added to the print function information only by the general-purpose printing software 202. Further, even when the halftone selection function is originally included in the print function information, the general-purpose printing software 202 cannot interpret the halftone selection function included in the print function information. Therefore, the halftone setting cannot be displayed on the detailed settings screen. To cope with this, the print function extension unit 206 adds the halftone selection function to the print function information 203. Then, the print settings screen extension unit 205 displays the detailed settings screen 400C by referring to the capabilities information. With this, the extension application 204 can display the halftone setting on the detailed settings screen.

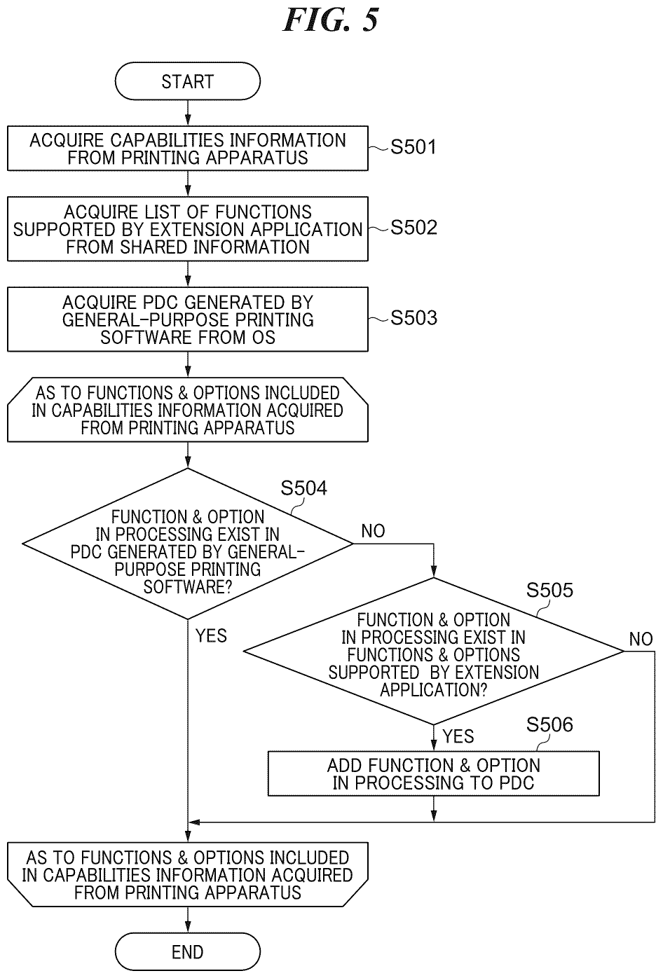

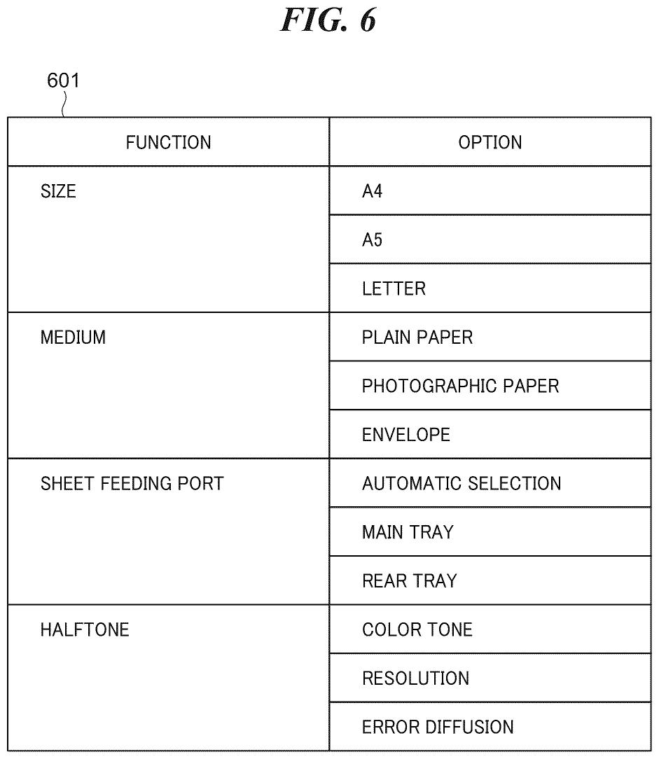

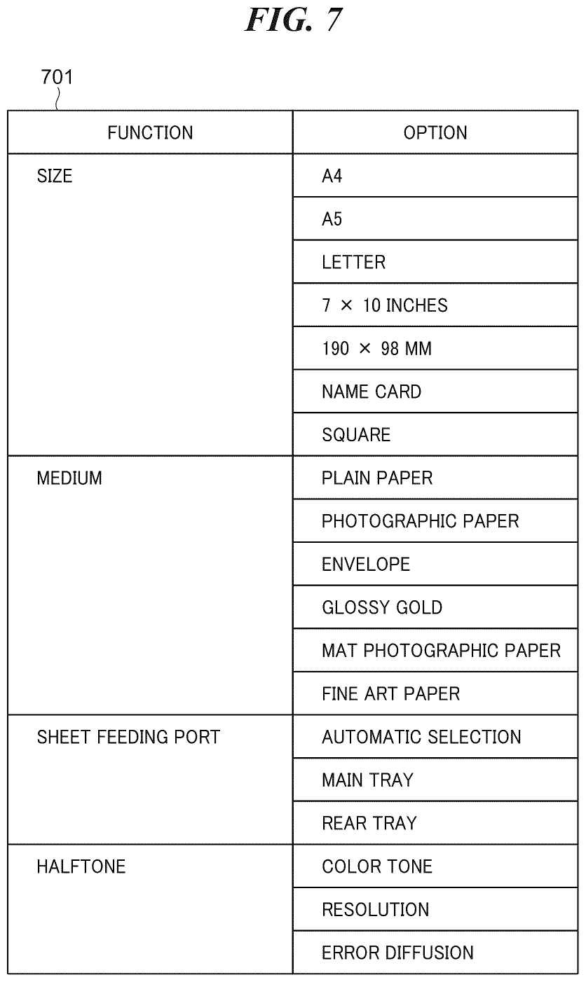

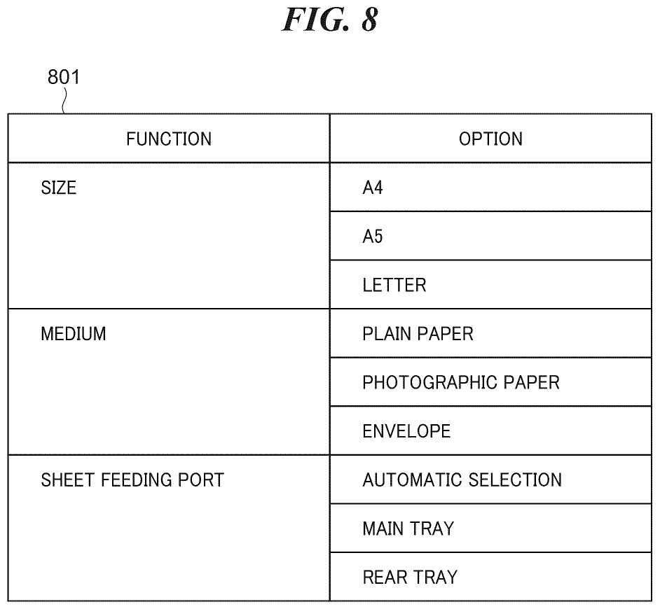

FIG. 5 is a flowchart of a print function information-editing process performed by the print function extension unit, for editing the print function information. Note that the program of the print function information-editing process in FIG. 5 is executed by the print function extension unit 206 under the control of the CPU 111. FIG. 6 is a diagram showing an example of a list of the capabilities information of the printing apparatus. FIG. 7 is a diagram showing an example of a list of the print functions supported by the extension application. FIG. 8 is a diagram showing an example of a list of the capabilities information of the general-purpose printing software. As shown in FIG. 5, in a step S501, the print function extension unit 206 acquires the capabilities information from the printing apparatus 102. The capabilities information is settings included in a response acquired by issuing the IPP “Get-Printer-Attributes” operation to the printing apparatus 102. The settings are the attribute information indicating functions which can be designated in the printing apparatus 102 and values concerning the attribute information. A table 601 shown in FIG. 6 shows a list of the capabilities information of the printing apparatus 102. For example, the capabilities information includes information on a size of sheets used for printing performed by the printing apparatus 102. The capabilities information further includes information on a type of sheets (media) used for printing performed by the printing apparatus 102, information on the sheet feeding port of sheets used for printing performed by the printing apparatus 102, and information on the halftone setting which can be executed by the printing apparatus 102. Note that this information on the halftone setting includes the above-described color tone, resolution, and error diffusion.

In a step S502, the print function extension unit 206 acquires the print functions supported by the extension application 204 from the shared information 208. In the shared information 208, a list of the print functions supported by the extension application 204 is stored. Then, this list includes all print functions which can be processed by the extension application 204 and the settings of those print functions. A table 701 shown in FIG. 7 includes information on the sheet size supported by the extension application 204 as the print function. The table 701 further includes the information on the type of sheets (media) supported by the extension application 204, the information on the sheet feeding port of sheets supported by the extension application 204, and the information on the halftone setting supported by the extension application 204. Note that similar to the table 601, the information on the halftone setting in the table 701 includes the above-described color tone, resolution, and error diffusion. Further, the print functions supported by the extension application 204 are sometimes updated e.g. due to the update of the extension application 204.

In a step S503, the print function extension unit 206 acquires the print function information 203 generated by the general-purpose printing software 202 from the OS. The print function information 203 is generated based on capabilities information 501 acquired by the general-purpose printing software 202 from the printing apparatus 102. The print function information 203 (PDC) generated by the general-purpose printing software 202 includes only the print functions supported by the general-purpose printing software 202 out of the capabilities information acquired from the printing apparatus 102. For example, in the table 701 shown in FIG. 7, 7×10 inches and 190×98 mm are included as the sheet size, but the general-purpose printing software 202 does not support these sheet sizes. Therefore, these sheet sizes are not included in the print function information 203. The print function extension unit 206 thus adds a function or option to the print function information 203, whereby the extension application 204 is capable of compensating for a function unsupported by the general-purpose printing software 202. Further, the print function extension unit 206 can also delete an unnecessary function or option from the print function information 203 generated by the general-purpose printing software 202.

Steps S504, S505, and S506 are processing operations which are repeatedly executed with respect to the function list held in the capabilities information acquired from the printing apparatus 102 in the step S501. In the present embodiment, the steps S504, S505, and S506 are repeatedly executed with respect to all of 12 options included in the table 701.

In the step S504, the print function extension unit 206 determines whether or not a function and an option being currently processed exist in the print function information 203 generated by the general-purpose printing software 202. In a case where it is determined in the step S504 that the corresponding function and option exist in the print function information 203, if the last item in the options is being processed, the process is terminated. Alternatively, unless the last item in the options is being processed, the next item is selected from the options, and the step S504 is executed again. On the other hand, if it is determined in the step S504 that the corresponding function and option do not exist in the print function information 203, the process proceeds to the step S505. For example, in the present embodiment, the sheet size “A4” is included in the table 601, and the sheet size “A4” is also included in a table 801. In this case, in the step S504, it is determined that the function and option being currently processed exist in the print function information 203. On the other hand, the halftone setting “color tone” is included in the table 601 but the halftone setting “color tone” is not included in the table 801. In this case, in the step S504, it is determined that the function and option being currently processed do not exist in the print function information 203.

In the step S505, the print function extension unit 206 determines whether or not the function (option) being currently processed exists in the functions (options) supported by the extension application 204. If it is determined in the step S505 that the function being currently processed exists, the process proceeds to the step S506. On the other hand, in a case where it is determined in the step S505 that the function being currently processed does not exist, similarly to the case where the answer to the question of the step S504 is affirmative (YES), the process is terminated if the last item in the options is being processed. Alternatively, unless the last item in the options is being processed, the next item is selected from the options, and the step S504 is executed again. For example, in the present embodiment, in a case where the function being currently processed is the halftone setting “color tone”, the halftone setting “color tone” also exists in the table 701. Therefore, it is determined in the step S505 that the function being currently processed exists.

In the step S506, the print function extension unit 206 adds the function (option) being currently processed to the print function information 203. After execution of the step S506, similarly to the case where the answer to the question of the step S504 is affirmative (YES), the process is terminated if the last item in the options is being processed. Alternatively, unless the last item in the options is being processed, the next item is selected from the options, and the step S504 is executed again.

As described above, the extension application 204 can add a function (option) which is not supported by the general-purpose printing software 202 but can be supported by the printing apparatus 102 and can be supported by the extension application 204, to the print function information 203. Then, the capabilities information (PC) is generated based on the print function information 203 edited by this addition processing. Further, the print settings screen extension unit 205 can extend a function which is not supported by the general-purpose printing software 202 and display the detailed settings screen 400C shown in FIG. 4C, by generating a display screen based on the capabilities information.

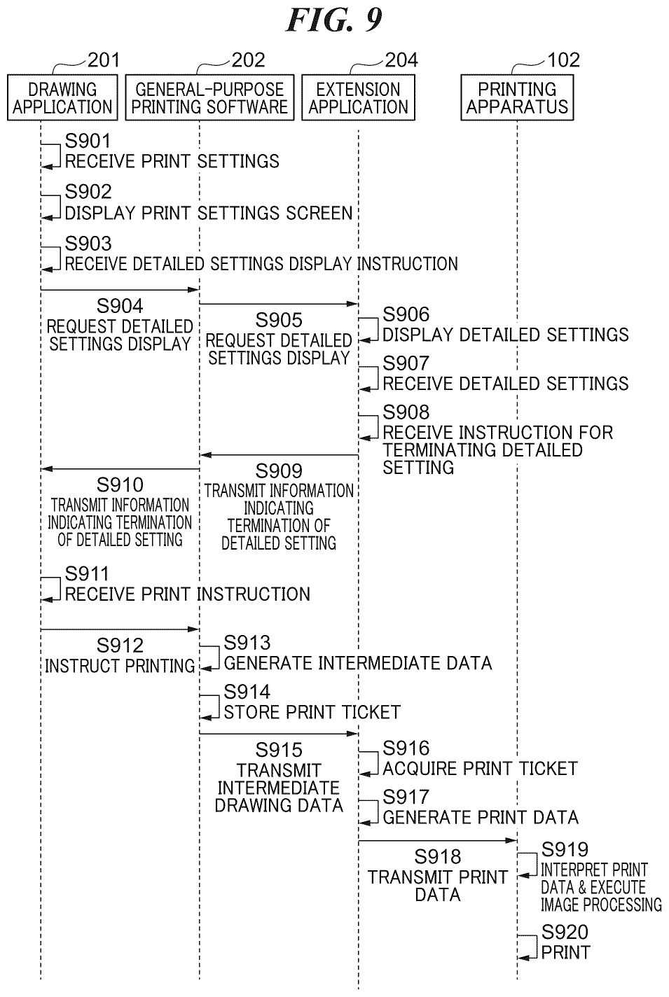

FIG. 9 is a sequence diagram showing a process executed between the drawing application, the general-purpose printing software, the extension application, and the printing apparatus, after the drawing application receives print settings. The processing operations in the drawing application, the general-purpose printing software, and the extension application are executed by the CPU 111 of the host computer 101. This processing program has been stored in the external storage device 114. Then, the CPU 111 loads the processing program from the external storage device 114 into the RAM 113 and executes the loaded program. Further, the processing in the printing apparatus 102 is executed by a CPU (not shown) of the printing apparatus 102. Further, the software configuration of the printing system 1000 is the software configuration shown in FIG. 2B.

As shown in FIG. 9, in a step S901, the drawing application 201 receives print settings set by the user. The user can instruct the print settings to the drawing application 201 by operating e.g. the pointing device 117 and the keyboard 118.

In a step S902, the drawing application 201 displays the print settings screen 400A shown in FIG. 4A on the display section 119.

In a step S903, the drawing application 201 receives a detailed settings display instruction provided by the user. The user can provide the detailed settings display instruction, by operating e.g. the pointing device 117 and the keyboard 118 to select the control 405 on the print settings screen 400A.

In a step S904, the drawing application 201 requests the general-purpose printing software 202 to display the detailed setting.

In a step S905, the general-purpose printing software 202 requests the extension application 204 to display the detailed settings.

In a step S906, the print settings screen extension unit 205 of the extension application 204 displays the detailed settings screen 400C shown in FIG. 4C. As described above, the halftone setting is added to the print function information 203 (PDC) by the print function extension unit 206. The print settings screen extension unit 205 can display the detailed settings screen 400C by referring to the capabilities information (PC) generated based on the print function information 203 to which the halftone setting has been added.

In a step S907, the print settings screen extension unit 205 receives the detailed settings made by the user on the detailed settings screen 400C. Here, on the detailed settings screen 400C, the sheet type “plain paper” is selected by the control 406, the sheet size “A4” is selected by the control 407, and the sheet feeding port “automatic” is selected by the control 408, by way of example. Further, the halftone setting “resolution” is selected by the control 410. In this setting state, the print settings screen extension unit 205 receives the operation of the control 409 on the detailed settings screen 400C, which is performed by the user.

In a step S908, the print settings screen extension unit 205 receives termination of the detailed setting, which is performed by the user, based on the operation of the control 409 in the step S907. The user can instruct termination of the detailed setting by operating e.g. the pointing device 117 and the keyboard 118 to select the control 409.

In a step S909, the extension application 204 sends detailed setting termination information to the effect that the detailed setting is terminated in the step S908, to the general-purpose printing software 202.

In a step S910, the general-purpose printing software 202 receives the detailed setting termination information sent from the extension application 204 in the step S909. The general-purpose printing software 202 sends the detailed setting termination information to the drawing application 201.

In a step S911, the drawing application 201 receives a print instruction provided by the user. The user can provide the print instruction by operating e.g. the pointing device 117 and the keyboard 118 to select the control 403 on the print settings screen 400A (see FIG. 4A).

In a step S912, the drawing application 201 provides the print instruction received in the step S911 to the general-purpose printing software 202.

In a step S913, the general-purpose printing software 202 generates the intermediate data based on the print instruction received in the step S912 by using the module of the OS.

In a step S914, the general-purpose printing software 202 stores the print settings information (PT) based on the print instruction received in the step S912 in the shared information 208.

In a step S915, the general-purpose printing software 202 sends the drawing data of the intermediate data generated in the step S913 to the extension application 204.

In a step S916, the intermediate data edit unit 207 of the extension application 204 acquires the print settings information stored in the step S914 from the shared information 208.

In a step S917, the intermediate data edit unit 207 of the extension application 204 generates print data using the drawing data sent in the step S915 and the print settings information acquired in the step S916.

In a step S918, the intermediate data edit unit 207 of the extension application 204 transmits the print data generated in the step S917 to the printing apparatus 102.

In a step S919, the printing apparatus 102 receives the print data transmitted in the step S918. The printing apparatus 102 interprets the print data and performs necessary image processing on the print data. As the image processing performed in this step, the halftone processing using the resolution pattern is performed. With this, for example, compared with a case where the halftone processing using the color tone pattern is performed without performing the halftone selection, image data from which jaggies have been reduced is generated.

In a step S920, the printing apparatus 102 prints the print data on which the image processing has been performed in the step S919. With this, an image from which jaggies have been reduced is output.

As described above, in the printing system 1000, even in a case where the general-purpose printing software 202 does not support the halftone processing, the extension application 204 can cause the printing apparatus 102 to execute the halftone processing. With this, a printed matter on which the halftone has been processed (reflected) is printed by the printing apparatus 102. Note that although in the description given with reference to FIG. 9, the detailed settings screen 400C shown in FIG. 4C is displayed assuming that the software configuration of the printing system 1000 is the software configuration shown in FIG. 2B, this is not limitative. For example, in a case where the detailed settings display request is provided to the general-purpose printing software 202 in the step S904, the general-purpose printing software 202 displays the detailed settings screen 400B shown in FIG. 4B. In this case, after the control 409 on the detailed settings screen 400B is operated, the general-purpose printing software 202 requests the extension application 204 to display an additional detailed settings screen. Then, the extension application 204 can additionally display a detailed settings screen on which the halftone setting can be made. Further, in the present embodiment, the extension application 204 generates the print data from the intermediate data generated by the general-purpose printing software 202, but this is not limitative, and, for example, the extension application 204 itself can generate the intermediate data.

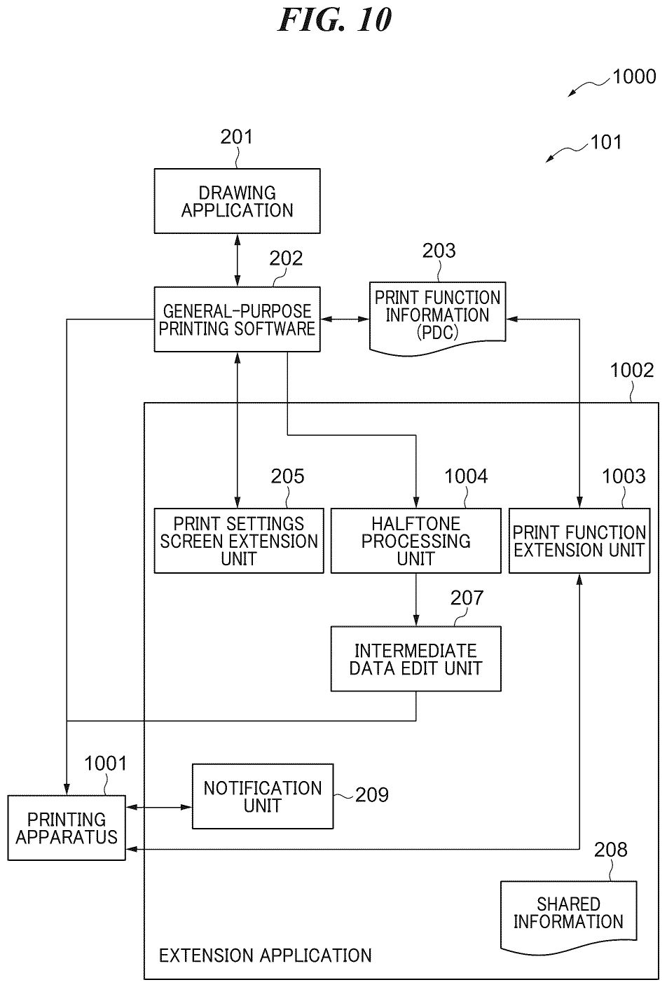

A second embodiment of the present invention will be described below with reference to FIGS. 10 to 13, but the description will be given mainly of different points from the above-described embodiment, and the description of the same points is omitted. In the first embodiment, the extension application 204 generate print data including the halftone setting, in cooperation of the general-purpose printing software 202. The print data is transmitted to the printing apparatus 102. The printing apparatus 102 can interpret the print data including the halftone setting and execute the halftone processing by using a halftone processing module (not shown) installed in the printing apparatus 102. Thus, in the first embodiment, the extension application 204 causes the printing apparatus 102 to execute the halftone processing in cooperation with the general-purpose printing software 202.

However, there is a case where the halftone processing module has not been installed, depending on the printing apparatus 102. In this case, even when the extension application 204 generates print data including the halftone setting, it is impossible to cause the printing apparatus 102 to execute the halftone processing. In a case where the halftone processing module has not been installed in the printing apparatus 102, it is preferable that print data is generated by the extension application 204 after executing the halftone processing, and is transmitted to the printing apparatus 102.

To cope with this, in the present embodiment, whether or not the halftone processing module has been installed is determined based on the capabilities information of the printing apparatus 102. As a result of this determination, if it is determined that the halftone processing module has been installed, print data on which the halftone setting has been reflected is generated by the extension application 204 and is transmitted to the printing apparatus 102. On the other hand, if it is determined that the halftone processing module has not been installed, print data is generated after the halftone processing is executed on the drawing data by the extension application 204, and the generated print data is transmitted to the printing apparatus 102. With this, even in a case where the halftone processing module has not been installed, it is possible to provide the halftone selection function to the user. Note that the present embodiment is the same as the first embodiment except that the configuration of the printing system 1000 in a case where the extension application 204 is associated with the printing apparatus 102 and the general-purpose printing software 202, the PDC editing processing, and the process performed after the drawing application 201 receives the print settings are different.

FIG. 10 is a block diagram showing a software configuration of the printing system according to the second embodiment. FIG. 10 shows the configuration in the case where an extension application 1002 is associated with the general-purpose printing software 202 and a printing apparatus 1001. As shown in FIG. 10, the host computer 101 includes the drawing application 201, the general-purpose printing software 202, the print function information 203, and the extension application 1002. Further, the extension application 1002 is communicably connected to the printing apparatus 1001. Differently from the printing apparatus 102 in the first embodiment, the printing apparatus 1001 is a printing apparatus in which the halftone processing module is not installed. The extension application 1002 includes the print settings screen extension unit 205, the intermediate data edit unit 207, the notification unit 209, a print function extension unit 1003, and a halftone processing unit 1004. The print function extension unit 1003 can add the halftone selection function to the print function information 203, even in a case where it is determined based on the capabilities information acquired from the printing apparatus 1001 that the printing apparatus 1001 is not equipped with the halftone selection function. The halftone processing unit 1004 performs the halftone processing on intermediate data (drawing data) received from the general-purpose printing software 202 based on the halftone setting set by the user.

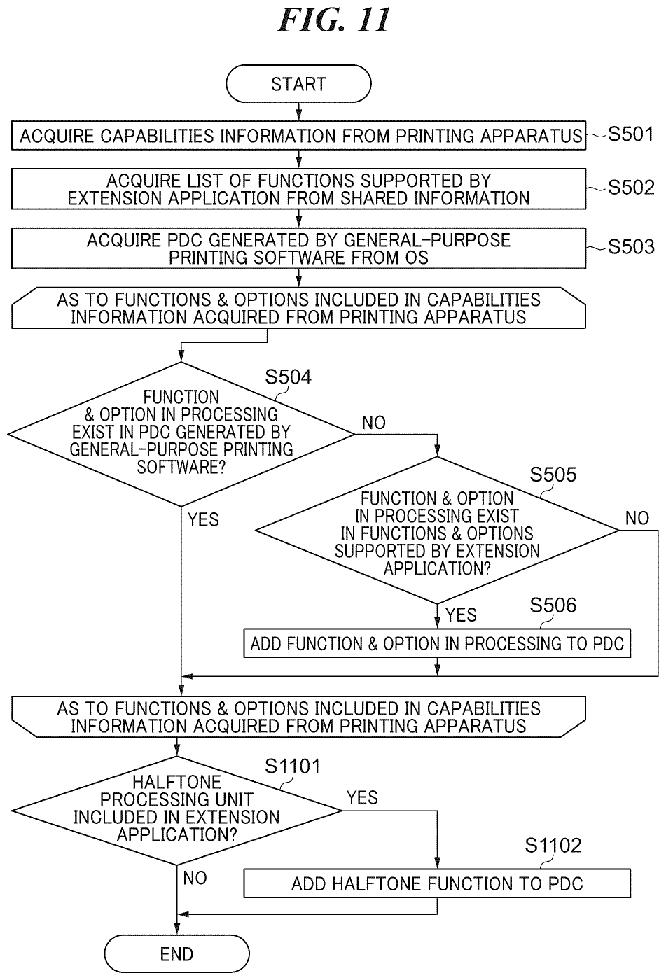

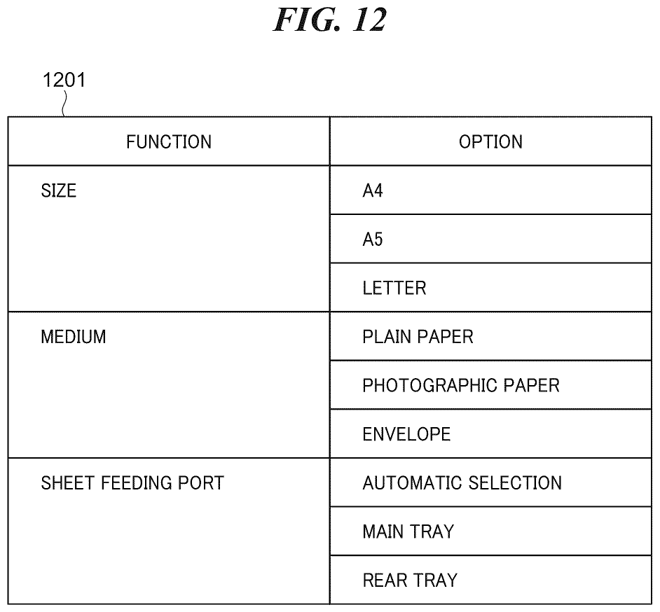

FIG. 11 is a flowchart of a print function information-editing process performed by the print function extension unit, for editing the print function information. Note that the program of the print function information-editing process in FIG. 11 is executed by the print function extension unit 1003 under the control of the CPU 111. Further, in the print function information-editing process in FIG. 11, steps S1101 and S1102 are added to the print function information-editing process in FIG. 5. FIG. 12 is a diagram showing an example of a list of the capabilities information of the printing apparatus.

As shown in FIG. 11, in a case where the process for repeating the steps S504 to S506 is terminated, the process proceeds to the step S1101. A table 1201 shown in FIG. 12 shows a list of the capabilities information of the printing apparatus 1001. The table 1201 includes the information on the sheet size, the information on the sheet type, and the information on the sheet feeding port of sheets, as capabilities information, but does not include the information on the halftone setting, differently from the table 601 shown in FIG. 6. Therefore, it is understood that the halftone processing module is not installed in the printing apparatus 1001. For this reason, the halftone function is not added to the print function information 203 after the processing of the steps S504 to S506 is terminated.

As shown in FIG. 11, in the step S1101, the print function extension unit 1003 determines whether or not the halftone processing unit 1004 is included in the extension application 1002, i.e. presence/absence of the halftone processing unit 1004. If it is determined in the step S1101 that the halftone processing unit 1004 is included, the process proceeds to the step S1102. On the other hand, if it is determined in the step S1101 that the halftone processing unit 1004 is not included, the process is terminated. As described above, since the extension application 1002 includes the halftone processing unit 1004, the process proceeds to the step S1102.

In the step S1102, the print function extension unit 1003 adds the information on the halftone setting (the color tone, the resolution, and the error diffusion) in the table 601 shown in FIG. 6, which is supported by the extension application 1002, to the print function information 203.

As described above, the extension application 1002 can add a function (option) which is not supported by the general-purpose printing software 202 but can be supported by the printing apparatus 1001 and can be supported by the extension application 1002, to the print function information 203. Then, the extension application 1002 determines presence/absence of the halftone processing unit 1004. As a result of the determination, if it is determined that the halftone processing unit 1004 exists, the halftone function is added to the print function information 203. With the addition processing, even in a case where the halftone processing module is not included in the printing apparatus 1001, the capabilities information is generated based on the print function information 203 to which the halftone function is added. The extension application 1002 can display the detailed settings screen 400C shown in FIG. 4C by generating the display screen based on the capabilities information.

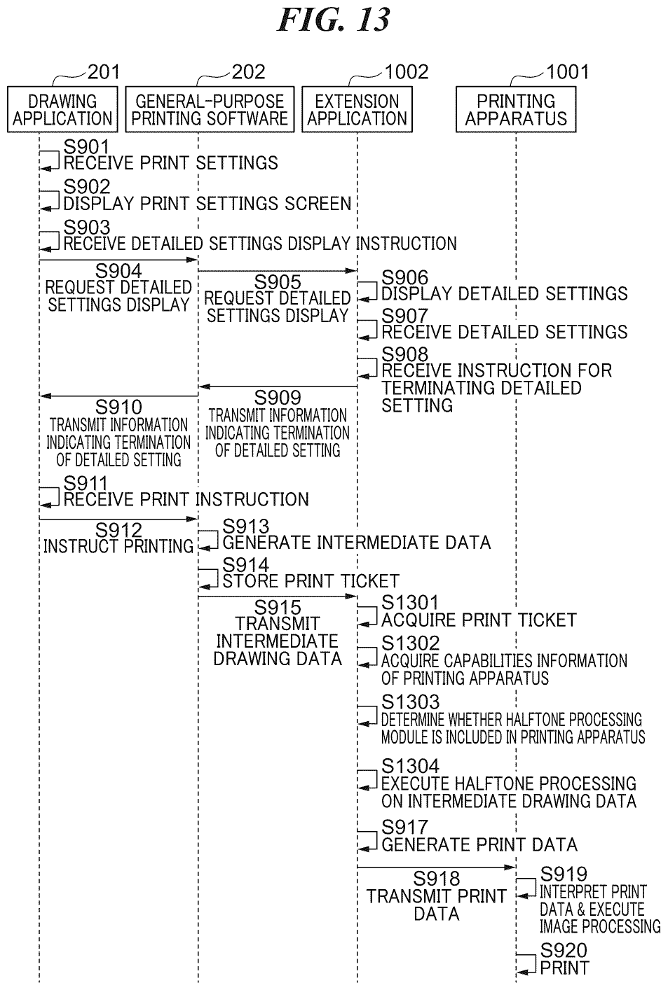

FIG. 13 is a sequence diagram showing a process executed between the drawing application, the general-purpose printing software, the extension application, and the printing apparatus after the drawing application receives print settings. The sequence diagram in FIG. 13 is mainly configured such that steps S1301 to S1304 are added to the sequence diagram shown in FIG. 9. As shown in FIG. 13, after execution of the step S915, the process proceeds to the step S1301. In the step S1301, the halftone processing unit 1004 of the extension application 1002 acquires the print settings information (PT) stored in the step S914 from the shared information 208. Further, the halftone processing unit 1004 acquires the information on the halftone setting, which is included in the print settings information.

In the step S1302, the halftone processing unit 1004 acquires the capabilities information of the printing apparatus 1001 from the shared information 208. Note that in a case where the capabilities information of the printing apparatus 1001 is not included in the shared information 208, the print function extension unit 1003 can request the capabilities information to the printing apparatus 1001. In this case as well, the capabilities information is stored in the shared information 208.

In the step S1303, the halftone processing unit 1004 determines, based on the capabilities information acquired in the step S1302, whether or not the halftone processing module is included in the printing apparatus 1001. As mentioned above, in the present embodiment, the halftone processing module is not installed in the printing apparatus 1001. Therefore, it is determined in the step S1303 that the halftone processing module is not included in the printing apparatus 1001. Note that if it is determined in the step S1303 that the halftone processing module is included in the printing apparatus 1001, the process skips the step S1304 and proceeds to the step S917. This is because the halftone processing module of the printing apparatus 1001 can execute the halftone processing at higher speed than the halftone processing unit 1004. Specifically, the halftone processing module of the printing apparatus 1001 can generate a sample at higher speed than the halftone processing unit 1004 by using the Application Specific Integrated Circuit (ASIC).

In the step S1304, the halftone processing unit 1004 performs the halftone processing on the intermediate drawing data (intermediate data) based on the information on the halftone setting, which is acquired in the step S1301. This processing result is stored in the shared information 208. Further, the halftone processing unit 1004 deletes the information on the halftone setting from the print settings information. After execution of the step S1304, the process sequentially proceeds to the steps S917 to S920.

As described above, in the present embodiment, even in a case where the halftone processing module is not installed in the printing apparatus 1001, the extension application 1002 can execute the halftone processing in cooperation with the general-purpose printing software 202, in place of the halftone processing module. With this, a printed matter on which the halftone has been processed is also printed by the printing apparatus 1001. Thus, in the present embodiment, if it is determined that the halftone processing module has not been installed in the printing apparatus 1001, it is possible to execute the halftone processing in cooperation with the general-purpose printing software 202. On the other hand, if it is determined that the halftone processing module is installed in the printing apparatus 1001, similarly to the first embodiment, in cooperation with the general-purpose printing software 202, it is also possible to cause the printing apparatus 1001 to execute the halftone processing.

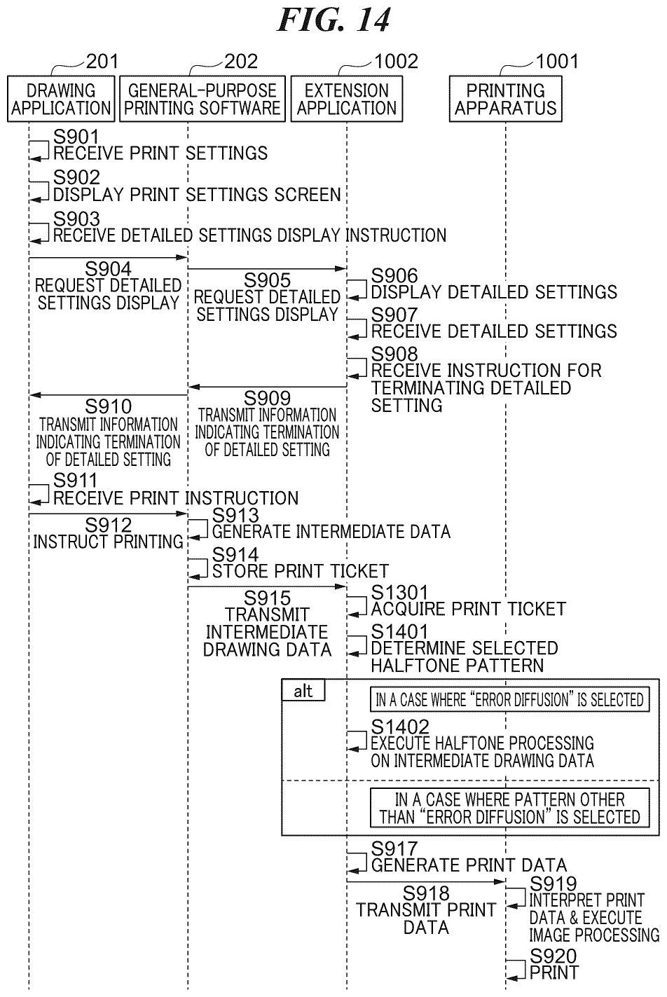

A third embodiment of the present invention will be described below with reference to FIG. 14, but the description will be given mainly of different points from the above-described embodiments, and the description of the same points is omitted. In the first embodiment, the description has been given of the case where the halftone processing is executed by the printing apparatus 1001, and in the second embodiment, the description has been given of the case where the halftone processing is executed by the extension application 1002. However, in the case where the halftone processing is executed by the printing apparatus 1001, there is a possibility that, for example, the ASIC has not been equipped, depending on the printing apparatus 1001, and it is difficult to execute high-speed halftone processing. Particularly, as for the halftone processing which is relatively high in costs of calculation, such as by the error diffusion method, the CPU 111 in the host computer 101 can be higher in performance than the CPU in the printing apparatus 1001. Therefore, there is a case where the halftone processing can be executed at higher speed when the halftone processing is executed by the extension application 1002.

Then, in the present embodiment, the halftone processing is performed by the printing apparatus 1001 or the extension application 1002 according to the halftone processing (execution condition) selected by the user. As an example of this, in a case where the error diffusion pattern is selected, the halftone processing is executed by the extension application 1002, whereas in a case where a halftone processing pattern other than the error diffusion pattern is selected, the halftone processing is executed by the printing apparatus 1001. Note that the present embodiment is the same as the first and second embodiments except that the process performed after the drawing application 201 receives the print settings is different.

FIG. 14 is a sequence diagram showing a process executed between the drawing application, the general-purpose printing software, the extension application, and the printing apparatus, after the drawing application receives print settings in the third embodiment. The sequence diagram in FIG. 14 is a sequence diagram formed mainly by adding steps S1401 and S1402 to the sequence diagram shown in FIG. 13. As shown in FIG. 14, after execution of the step S1301, the process proceeds to the step S1401. In the step S1401, the halftone processing unit 1004 of the extension application 1002 determines, based on the halftone setting acquired in the step S1301, whether or not the selected halftone processing pattern is a specific halftone pattern, i.e. the error diffusion pattern. If it is determined in the step S1401 that the selected halftone processing pattern is the error diffusion pattern, the process proceeds to the step S1402. On the other hand, if it is determined in the step S1401 that the selected halftone processing pattern is not the error diffusion pattern, the process sequentially proceeds to the steps S917 to S920.

In the step S1402, the halftone processing using the error diffusion method is performed on the intermediate drawing data (intermediate data). This processing result is stored in the shared information 208. After execution of the step S1402, the process sequentially proceeds to the steps S917 to S920. Note that although in the step S919, the printing apparatus 1001 executes necessary image processing on the image of the print data, in a case where the halftone processing has been performed in the step S1402, image processing except the halftone processing is executed.

As described above, in the present embodiment, it is possible to execute the halftone processing by the printing apparatus 1001 or the extension application 1002 according to the halftone processing. This makes it possible to execute the halftone processing at high speed, in other words, the halftone processing which is relatively high in calculation costs is executed by the extension application, and the halftone processing which is relatively low in calculation costs is executed by the printing apparatus 1001.

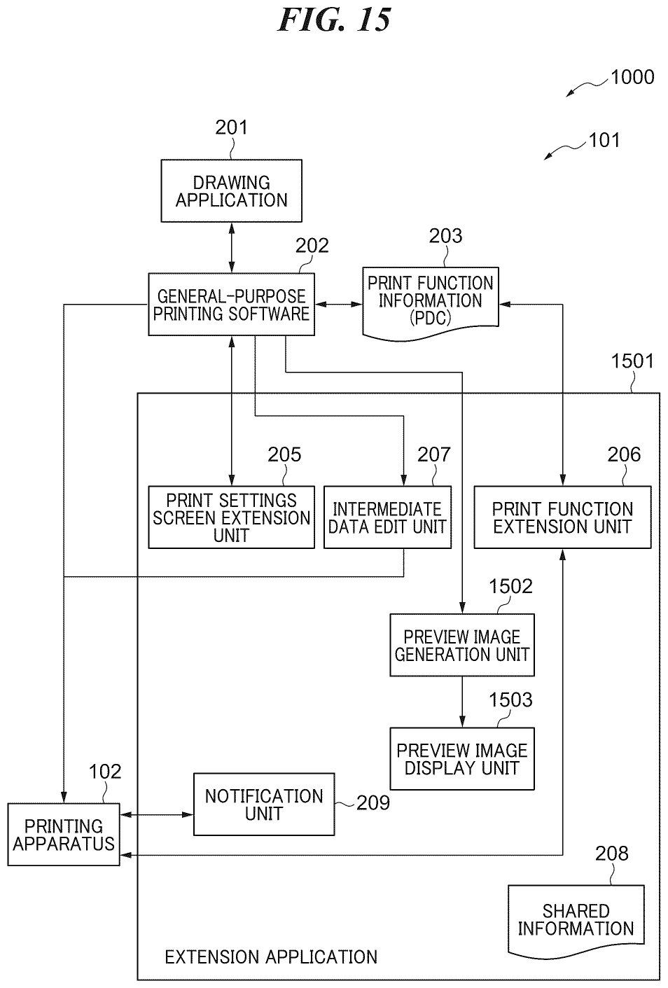

A fourth embodiment of the present invention will be described below with reference to FIGS. 15 to 17, but the description will be given mainly of different points from the above-described embodiments, and the description of the same points is omitted. When the halftone setting is switched, this change is not reflected on the preview screen of the control 402 on the print settings screen 400A shown in FIG. 4A. Further, a change in image quality, which is caused by the change of the halftone setting, becomes minute depending on print data, and unless the preview screen is enlarged, it can be difficult to confirm the change in image quality.

To solve this problem, in the present embodiment, the halftone processing selected by the user is displayed on the preview screen displayed on the control 402 in an enlarged state. The present embodiment is the same as the first embodiment except the configuration of the printing system 1000, the print settings screen displayed by the print settings screen extension unit 205, and the process performed after an extension application 1501 receives the print settings.

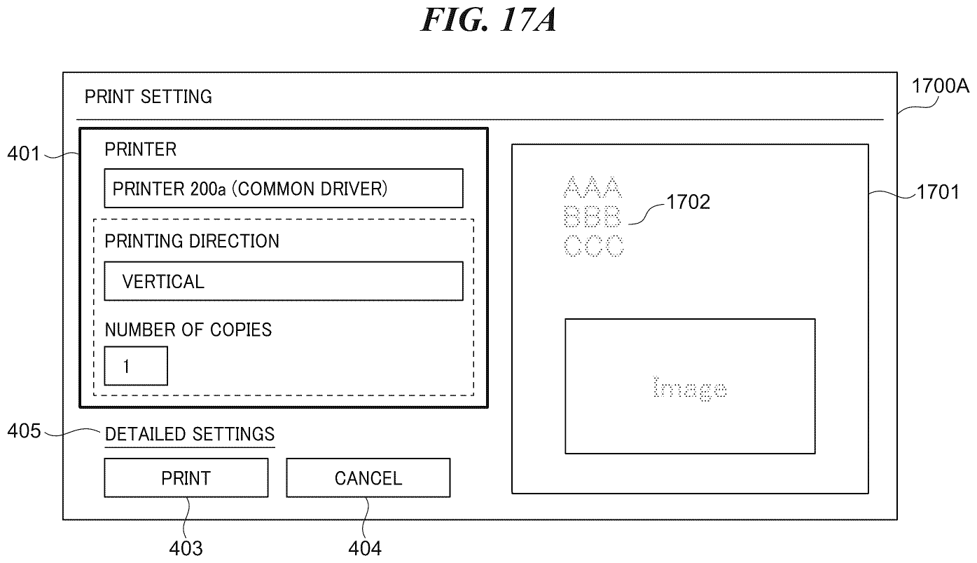

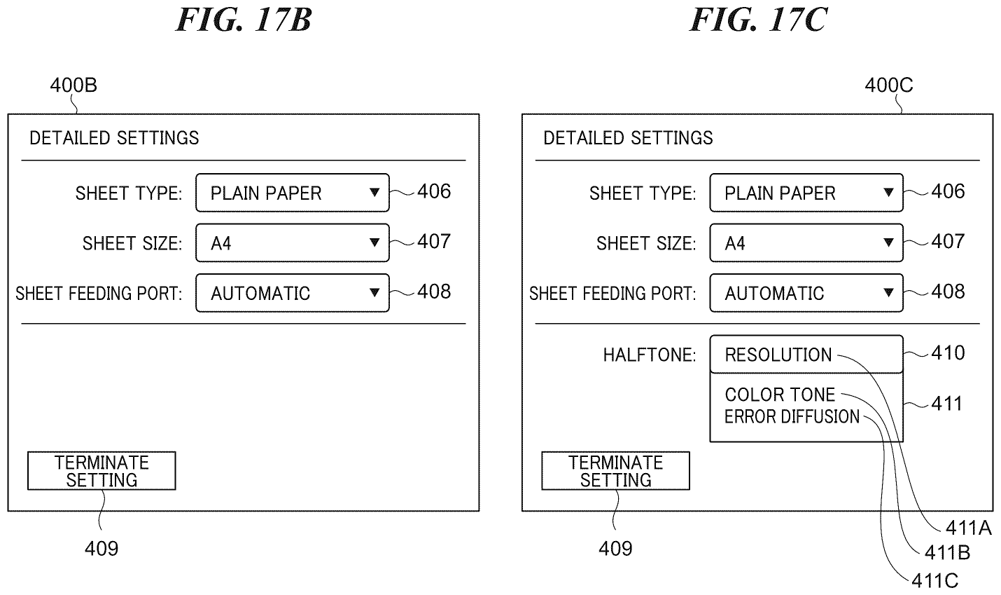

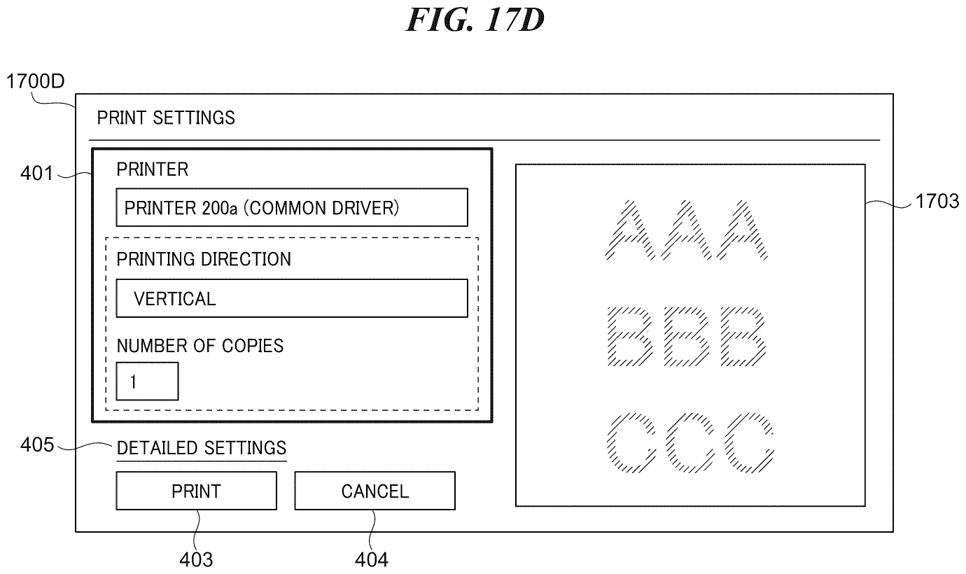

FIG. 15 is a block diagram showing a software configuration of the printing system according to the fourth embodiment. As shown in FIG. 15, the printing system 1000 has the extension application 1501. The extension application 1501 includes the print settings screen extension unit 205, the print function extension unit 206, the intermediate data edit unit 207, the notification unit 209, a preview image generation unit 1502, and a preview image display unit 1503. The preview image generation unit 1502 performs the halftone processing on an image of intermediate data (drawing data) received from the general-purpose printing software 202, based on the halftone setting set by the user. Further, the preview image generation unit 1502 generates a preview image on which the halftone processing has been reflected. The preview image display unit 1503 displays the preview image generated by the preview image generation unit 1502 as a preview screen 1701 (see FIG. 17A).

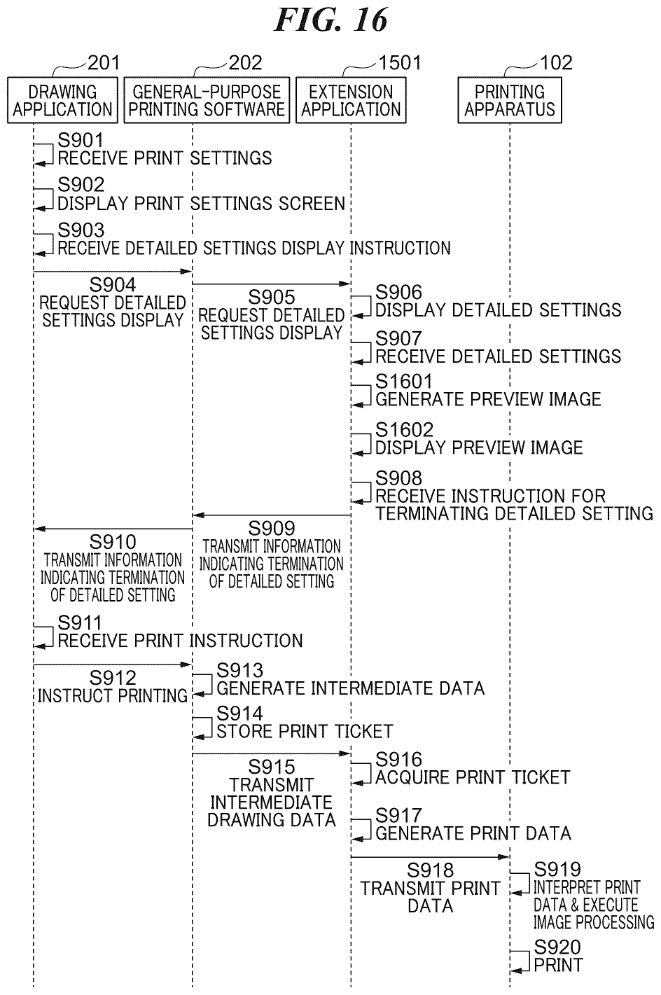

FIG. 16 is a sequence diagram showing a process executed between the drawing application, the general-purpose printing software, the extension application, and the printing apparatus, after the drawing application receives print settings. The sequence diagram in FIG. 16 is a sequence diagram formed mainly by adding steps S1601 and S1602 to the sequence diagram shown in FIG. 9. FIGS. 17A to 17D are diagrams each showing an example of a screen displayed on the display section of the printing system. FIG. 17A shows a print settings screen displayed by the drawing application 201. FIG. 17B shows a detailed settings screen displayed in a case where a configuration in which the extension application 1501 is not associated with the printing apparatus 102 and the general-purpose printing software 202 is employed. FIG. 17C shows a detailed settings screen displayed in a case where a configuration in which the extension application 1501 is associated with the printing apparatus 102 and the general-purpose printing software 202 is employed. FIG. 17D shows a print settings screen displayed by the preview image display unit 1503.

As shown in FIG. 16, after execution of the step S907, the process proceeds to the step S1601. In the step S1601, the preview image generation unit 1502 of the extension application 1501 executes the halftone processing on the drawing data in the intermediate data acquired from the general-purpose printing software 202, according to the detailed setting (halftone setting) received in the step S907. Then, the preview image generation unit 1502 generate a preview image on which the halftone processing has been reflected. For example, there is a case where coordinates of a character part 1702 in the preview screen 1701 on the print settings screen, denoted by reference numeral 1700A, shown in FIG. 17A are included. In this case, based on the coordinates of the character part 1702, an enlarged image for displaying a range of 1000 pixels in both of vertical and lateral directions on the preview screen can be generated from the coordinates of the character part 1702 and be set as the preview image. Note that the method of generating the enlarged image is not limited to the above-described method, but for example, a range of the specified number of pixels from an upper left end of the preview screen 1701 can be designated. Further, the range to be designated can be larger or smaller than this range. Further, the processing for generating the enlarged image can be omitted.

In the step S1602, the preview image display unit 1503 of the extension application 1501 displays the preview image generated in the step S1601 as a preview screen 1703 on a print settings screen 1700D shown in FIG. 17D. After execution of the step S1602, the process sequentially proceeds to the steps S908 to S920. As described above, in the present embodiment, it is possible to display a change in image quality, which is caused by the selected halftone processing, in an enlarged image as the preview, and therefore, the user can easily confirm the change in image quality on the displayed enlarged image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-134053 filed Aug. 21, 2023, which is hereby incorporated by reference herein in its entirety.

What is claimed is:

1. A non-transitory computer-readable storage medium storing a program for causing a computer to execute a method of controlling a function of a general-purpose program which can be commonly used for printing apparatuses of a plurality of makers, such that the function can be extended,
wherein the method comprises:
causing the printing apparatus to execute halftone processing for generating image data for expressing halftone on a printed matter printed based on print data generated by the general-purpose program.

2. The non-transitory computer-readable storage medium according to claim 1, wherein the method further comprises:
acquiring capabilities information concerning capabilities of the printing apparatus for performing printing, from the printing apparatus, before execution of the halftone processing; and
determining, based on the capabilities information acquired by said acquiring, whether or not the printing apparatus can execute the halftone processing,
wherein said execution of the halftone processing includes:
causing, in a case where, as a result of said determining, it is determined that the printing apparatus can execute the halftone processing, the printing apparatus to execute the halftone processing, and
executing, in a case where it is determined that the printing apparatus cannot execute the halftone processing, the halftone processing without using the printing apparatus.

3. The non-transitory computer-readable storage medium according to claim 1, wherein the method further comprises selecting and setting, before execution of the halftone processing, an execution condition used when executing the halftone processing, and
wherein said execution of the halftone processing includes converting intermediate data generated by the general-purpose program to the image data which can be printed by the printing apparatus, based on the execution condition set by said setting.

4. The non-transitory computer-readable storage medium according to claim 3, wherein said setting includes displaying a setting screen on which the execution condition can be selected and set.

5. The non-transitory computer-readable storage medium according to claim 4, wherein in the setting screen, at least one of a color tone section for selecting a color tone, a resolution section for selecting a resolution, and an error diffusion section for selecting error diffusion is included as the execution condition.

6. The non-transitory computer-readable storage medium according to claim 5, wherein in a case where the color tone section or the resolution section is selected, processing using AM screen is used for the halftone processing.

7. The non-transitory computer-readable storage medium according to claim 6, wherein the density of dots or lines formed by the dots in the AM screen is higher in the resolution section than in the color tone section.

8. The non-transitory computer-readable storage medium according to claim 5, wherein in a case where the error diffusion section is selected, an error diffusion method is used for the halftone processing.

9. The non-transitory computer-readable storage medium according to claim 3, wherein in said execution of the halftone processing, whether to cause the printing apparatus to execute the halftone processing or to execute the halftone processing can be selected according to the execution condition.

10. The non-transitory computer-readable storage medium according to claim 1, wherein as the general-purpose program, a program which cannot execute the halftone processing is used.

11. The non-transitory computer-readable storage medium according to claim 1, wherein as the general-purpose program, a program which operates based on the Internet Printing Protocol is used.

12. A non-transitory computer-readable storage medium storing a program for causing a computer to execute a method of controlling a function of a general-purpose program which can be commonly used for printing apparatuses of a plurality of makers, such that the function can be extended,
wherein the method comprises:
executing halftone processing for generating image data for expressing halftone on a printed matter printed based on print data generated by the general-purpose program.

13. The non-transitory computer-readable storage medium according to claim 12, wherein the method further comprises selecting and setting, before execution of the halftone processing, an execution condition used when executing the halftone processing, and
wherein said execution of the halftone processing includes converting intermediate data generated by the general-purpose program to the image data which can be printed by the printing apparatus based on the execution condition set by the setting.

14. The non-transitory computer-readable storage medium according to claim 13, wherein the setting includes displaying a setting screen on which the execution condition can be selected and set.

15. The non-transitory computer-readable storage medium according to claim 14, wherein in the setting screen, at least one of a color tone section for selecting a color tone, a resolution section for selecting a resolution, and an error diffusion section for selecting error diffusion is included as the execution condition.

16. The non-transitory computer-readable storage medium according to claim 15, wherein in a case where the color tone section or the resolution section is selected, processing using AM screen is used for the halftone processing.

17. The non-transitory computer-readable storage medium according to claim 16, wherein the density of dots or lines formed by the dots in the AM screen is higher in the resolution section than in the color tone section.

18. The non-transitory computer-readable storage medium according to claim 15, wherein in a case where the error diffusion section is selected, an error diffusion method is used for the halftone processing.

19. The non-transitory computer-readable storage medium according to claim 13, wherein in said execution of the halftone processing, whether to cause the printing apparatus to execute the halftone processing or to execute the halftone processing can be selected according to the execution condition.

20. The non-transitory computer-readable storage medium according to claim 12, wherein as the general-purpose program, a program which cannot execute the halftone processing is used.

21. The non-transitory computer-readable storage medium according to claim 12, wherein as the general-purpose program, a program which operates based on the Internet Printing Protocol is used.

22. A method of controlling a function of a general-purpose program which can be commonly used for printing apparatuses of a plurality of makers, such that the function can be extended,
wherein the method comprises:
causing the printing apparatus to execute halftone processing for generating image data for expressing halftone on a printed matter printed based on print data generated by the general-purpose program.

23. A method of controlling a function of a general-purpose program which can be commonly used for printing apparatuses of a plurality of makers, such that the function can be extended,
wherein the method comprises:
executing halftone processing for generating image data for expressing halftone on a printed matter printed based on print data generated by the general-purpose program.

24. An information processing apparatus that is communicably connected to printing apparatuses of a plurality of makers and processes information transmitted between the information processing apparatus and each printing apparatus, comprising:
a general-purpose program which can be commonly used for the printing apparatuses of the plurality of makers and a program which can extend a function of the general-purpose program,
wherein the program causes the printing apparatus to execute halftone processing for generating image data for expressing halftone on a printed matter printed based on print data generated by the general-purpose program.

25. An information processing apparatus that is communicably connected to printing apparatuses of a plurality of makers and processes information transmitted between the information processing apparatus and each printing apparatus, comprising:
a general-purpose program which can be commonly used for the printing apparatuses of the plurality of makers and a program which can extend a function of the general-purpose program,
wherein the program executes halftone processing for generating image data for expressing halftone on a printed matter printed based on print data generated by the general-purpose program.
